(19) United States
(12) Patent Application Publication
(10) Pub. No.: US 2026/0120984 A1
(43) Pub. Date: Apr. 30, 2026

(54) SWITCH WITH MAGNETIC BLOW-OUT OF ELECTRIC ARC, AND MANUFACTURING METHOD THEREOF

(71) Applicant: Gorlan Team, S.L.U., Amorebieta (ES)

(72) Inventor: Jose Oscar ANDALUZ SORLÍ, Zaragoza (ES)

(21) Appl. No.: 19/364,400

(22) Filed: Oct. 21, 2025

(30) Foreign Application Priority Data
Oct. 24, 2024 (EP) 24383170.8

(51) Int. Cl. H01H 33/18; H01H 33/53

(52) U.S. Cl. CPC H01H 33/182; H01H 33/53

(57) ABSTRACT

Disclosed is a switch including: a fixed contact and a movable contact, and a pair of magnets placed one above the other, and arranged such that a generated magnetic flux interfere, at least partially, with an electric arc that may be formed between the fixed and the movable contacts when switching from the On-position to the Off-position and vice versa. The magnets are placed relative to each other such that sides of the same polarity of the two magnets are closer to each other than the sides of the other polarity, and additionally the magnets of the pair of magnets are inclined with respect to each other. A method for manufacturing a switch with magnetic blow-out of the electric arc is disclosed.

### CROSS-REFERENCE TO RELATED APPLICATIONS

This application claims priority to European Patent Application No. 24383170.8, filed on Oct. 24, 2024, which is incorporated by reference in its entirety.

### TECHNICAL FIELD

The present disclosure relates in general to switches incorporating magnets for blowing-out the electric arc while switching On and Off.

An object of the disclosure is the provision of a switch with magnetic blow-out, which optimizes the performance of magnetic blowing in high voltage DC circuit breakers, using less magnets or magnets of reduced size, thereby, reducing manufacturing costs.

The use of the disclosure is especially advantageous in the field of direct current circuit breakers, in particular in demanding situations where the application voltage is in the range: 1500-2000 VDC.

### BACKGROUND

In the field of DC circuit breakers, there are particular demanding situations where the operating voltage is high 1500-2000 VDC.

A clear example of such demanding situations where this type of situation occurs is photovoltaic (PV) installations, which require specific equipment capable of delivering optimum performance under severe conditions.

One of the stringent requirements for such devices in the PV application is to ensure correct operation under critical load current in DC. The critical current is defined as the value of the cut-off current, within the range of operating conditions, in which the arc time is significantly extended.

This phenomenon, present in photovoltaic applications on the DC side, is due to the low magnetic field generated by the low arc current (generally lower than the rated current of a switch-disconnector), which creates a low mobility arc due to the reduced magnetic field created by the low value current.

The current of the photovoltaic string depends on the solar irradiation and thus on the time of the day. This is why low and critical currents occur mainly in the morning and evening.

The problem of critical current is further accentuated by the existing trend of increasing voltage values in PV installations to try to improve energy efficiency, such as the current values of 1500 VDC or the future 2000 VDC.

This increase in the voltage values in the Direct Current part of the Photovoltaic installations, causes the problem of increasing the effects of the electric field in the cut-off contacts of a switch that together with the little magnetic associated with a critical current, causes a stagnation of the electric arc increasing the duration times of the electric arc affecting the duration of the time of its extinction and causes irreversible damage to the contacts or even the destruction of the switch producing damage to adjacent equipment, facilities and people.

Among other techniques, magnetic blowing with permanent magnets is currently used to overcome this problem. For example, the European patent Application EP-2.690.639 A1 discloses a switch incorporating permanent magnets for blowing-out an electric arc.

Depending on the geometry and size of the circuit breaker, different sizes, quantities, arrangements and qualities of magnets are used in order to optimize the function and performance of DC circuit breakers.

In order to increase the ‘power’ of magnetic blowing due to the critical current factor in the case of PV systems with high voltages and to reduce arc extinction times, more magnets in groups or larger magnet sizes/volumes are being used as a solution, resulting in a greater increase in raw materials and affecting the environmental impact, as well as increasing the economic costs of a circuit breaker.

One way to increase the magnetic field density, or the area of influence of the magnetic field, is to use expensive magnets of larger sizes and volumes.

The grouping of several magnets in series or in parallel and/or in different geometrical positions within a switch are also used to achieve magnetic field directions and directions that favor arc extinction.

As represented in FIGS. 1A & 1B, these ways of using magnets to blow the electric arc in the opening of a circuit breaker have a lot of scattered flux that is not used, hence to obtain the same result it is necessary to increase the number of magnets or their size/volume, as only the region of the magnetic field closest to the contacts is used and also in a position that can favour a blowing that directs the arc towards the extinguishing chamber area (the left hand rule must be complied with).

Therefore, it remains a challenge to place the magnets in an ideal position inside a circuit breaker, as the volume of the circuit breaker has to be oversized for the ideal placement of the larger volume of magnets.

### SUMMARY

The scope of protection is defined in the attached claims, and the disclosure satisfactorily solves the above-described drawbacks of the prior art, by arranging a pair of magnets with respect to each other in a way to reduce the dispersed flux and increase their electric arc blowing-out capacity, achieving the same or greater results than prior art solutions, but with fewer magnets or with magnets of small size.

More specifically, a first aspect refers to a switch with magnetic blow-out of electric arc, wherein the switch conventionally comprises a fixed contact and a movable contact, wherein the movable contact is displaceable between an On-position in which it is electrically in contact with the fixed contact, and an Off-position in which the fixed and the movable contacts are spaced apart from each to prevent current circulation.

According to some embodiments, the switch further comprises at least a pair of magnets placed one above the other, and arranged such that a generated magnetic flux by the two magnets interfere, at least partially, with an electric arc that may be formed between the fixed and the movable contacts when switching from the On-position to the Off-position and vice versa.

Due to the relative position between the two magnets and the separation distance between them, a major part of the magnetic flux generated by the magnets flows in the same direction and are combined to increase magnetic field density towards the region of space wherein an electric arc is likely to appear.

Each magnet has a positive polarity side and a negative polarity side, and wherein the magnets of the pair of magnets are placed relative to each other, such that sides of the same polarity of the two magnets are closer to each other than the sides of the other polarity, and additionally the magnets of the pair of magnets are inclined with respect to each other.

The magnets of the pair of magnets are arranged relative to each other, such that a surface of a side of one magnet is within a first plane, and a surface of a side of the other magnet is within a second plane, and wherein the first and the second planes form an angle withing the range: more than 0° and less than 110°, and preferably around 100°.

Preferably, the two magnets of the pair of magnets are symmetrically arranged with respect to a plane of symmetry, and wherein sides of the magnets of the same polarity are closer to the plane of symmetry than the sides of the other polarity.

The movable contact is movable on a third plane, and wherein the plane of symmetry is coplanar with the third plane, or wherein the plane of symmetry is parallel to the third plane or to a part thereof.

With the above-described arrangement of magnets, the magnetic field density is increased towards the region of interest in the space, which is the region where an electric arc may be built up between the fixed and movable contact when switching from the On-position to the Off-position and vice versa. Therefore, the capacity to blow out an electric arc is increased simply by positioning the magnets as described above to generate a combined magnetic field and reducing the dispersed magnetic field, so there is no need to increase the number of magnets or their size to blow out electric arc in extreme operating conditions.

The switch further comprises conventionally at least one stack of arc-breaking plates placed nearby the fixed contact and the movable contact, and downstream the movable contact when the movable contact is in the On-position. According to some embodiments, the pair of magnets are placed downstream the stack of arc-breaking plates, with respect to the movement of the movable contact from the On-position towards the Off-position.

This arrangement of the magnets has the effect that the magnetic flux is blown towards the stack of arc-breaking plates, thereby increasing the arc blowing capacity of the switch.

In a preferred embodiment, the movable contact is a rotatable contact rotatable about an axis (X), and the switch has two pairs of magnets which are diametrically arranged with respect to the axis (X). The switch further comprises two fixed contacts and two stacks of arc-breaking plates, and the movable contact has two contact members parallel to each other and projecting from the axis (X) and configured for contacting with the two fixed contacts in the On-position of the switch.

The switch has a housing made of an electrically insulating material enclosing: the movable contact, part of the fixed contact, and the pair of magnets. The housing is formed by a first housing part and a second housing part, wherein one magnet is attached to an internal surface of the first housing part and the other magnet is attached to an internal surface of the second housing part.

Each housing part is generally a flat body extending on a plane, and wherein each housing part has in its inner side, a surface inclined with respect to said plane, and a magnet of the pair of magnets is placed on said inclined surface such that one side of the magnet is directly in contact with that inclined surface.

The magnets are located such that when the first and second housing parts are coupled together to configure the housing, the magnets are placed one above the other at a desired distance, and inclined with respect to each other.

In an alternative embodiment, the switch comprises:
a first sub-assembly in turn comprising:
   first and second casing parts made of an electrically insulating material, wherein the first casing part has a first inclined surface, and the second casing part has a second inclined surface,
   a first stack of arc-breaking plates coupled to the first casing part and/or to the second casing part,
   a first fixed contact coupled to the first upper casing part and/or to the second casing part, and
   a first pair of magnets such that a first magnet is placed on the first inclined surface, and a second magnet is placed on the second inclined surface,
a top cover and a bottom cover, both covers made of an electrically insulating material,
a movable contact displaceable between an On-position in which it is electrically in contact with the first fixed contact, and an Off-position in which the fixed contact and the movable contact are spaced apart from each to prevent current circulation, and
wherein the first sub-assembly, and the top and bottom covers are assembled together to configure the switch, such that a major part of the first sub-assembly is enclosed by the top and bottom covers (the whole assembly is enclosed by the top and bottom covers except for a part of the fixed contact which protrude outside the covers for their connection with cables).

In a preferred embodiment, the switch additionally includes a second sub-assembly which comprises:
third and fourth casing parts made of an electrically insulating material, wherein the third casing part has a third inclined surface, and the fourth casing part has a fourth inclined surface,
a second stack of arc-breaking plates coupled to the third casing part and/or to the fourth casing part,
a second fixed contact coupled to the third upper casing part and/or to the fourth casing part, and
a second pair of magnets such that a third magnet is placed on the third inclined surface, and a fourth magnet is placed on the fourth inclined surface.

This second sub-assembly would be also assembled together with the first sub-assembly, and with the top and bottom covers, such that a major part of both sub-assemblies is enclosed by the top and bottom covers, and the movable contact would be in contact with both fixed contacts in the On-position, and spaced apart from the fixed contacts in the Off-position.

The above definition of “inclined” referring to the placement of the magnets, is the same as the one given above for the first embodiment.

The above-described embodiment formed by sub-assemblies, allows a modular construction of the switch, such that different configurations of switches for different applications can be manufactured in a simple manner, for example simply by replacing the movable contact or the sub-assemblies by others of different working parameters.

Furthermore, said modular constructions allow the components of the switch, that is, the sub-assemblies or other parts of the switch, to be manufactured in several manufacturing sites, and assembled together in other facility.

The provision of the inclined surfaces in the housing parts, assure an accurate and simple placement of the magnets in the desired position during the switch manufacturing process.

Conventionally, each magnet is a prismatic or cylindrical body having two opposing flat surfaces.

In a preferred embodiment, the switch is adapted to feature a working voltage within the range of 1500-2000 VDC.

Another aspect refers to a method for manufacturing a switch with magnetic blow-out of electric arc, preferably a switch as the one previously described. The method comprises the steps of: providing a first housing part and a second housing part, both parts made of an electrically insulating material, and wherein each housing part has been formed as a generally flat body extending respectively on a first and second plane, and wherein each housing part is formed to have at an internal side thereof, an inclined surface with respect respectively to the first or second plane.

The method also comprises the step of providing, at least a pair of magnets, each magnet having a positive polarity side and a negative polarity side, and attaching first and second magnets of a pair of magnets, respectively on the inclined surfaces of the first and the second housing parts, such that sides of the first and second magnets of the same polarity are placed directly in contact with the respective inclined surface.

The method also comprises the step of providing a movable contact and a fixed contact, and bringing the first and the second housing parts together to configure a switch housing, and in a way that the movable contact and at least part of the fixed contact, are enclosed between the first and second housing parts, such that the movable contact is displaceable between an On-position in which it is electrically in contact with the fixed contact, and an Off-position in which the fixed and the movable contacts are spaced apart from each to prevent current circulation.

The inclined surfaces and the magnets are located respectively in first and the second housing parts, such that when the housing parts are placed one on top of the other and coupled, the magnets are arranged to generate a magnetic flux which interfere, at least partially, with an electric arc that may be formed between the fixed and the movable contact when switching from the On-position to the Off-position and vice versa. By bringing the first and the second housing parts together to configure a switch housing, the magnets are positioned above and inclined with respect to each other.

An alternative method for manufacturing the switch, comprises:
manufacturing at least a first sub-assembly by:
   coupling together first and second casing parts made of an electrically insulating material, such that the first casing part has a first inclined surface, and the second casing part has a second inclined surface, coupling a first stack of arc-breaking plates to the first casing part and/or to the second casing part,
   coupling a first fixed contact to the first upper casing part and/or to the second casing part, and
   placing a first magnet on the first inclined surface, and placing a second magnet on the second inclined surface,
providing a top cover and a bottom cover, both covers made of an electrically insulating material,
proving a movable contact,
assembling together the first sub-assembly, the top and bottom covers and the movable contact, to configure the switch, such that a major part of the first sub-assembly (the whole sub-assembly except for a part of the fixed contact) is enclosed by the top and bottom, and wherein
the movable contact is displaceable between an On-position in which it is electrically in contact with the first fixed contact, and an Off-position in which the fixed contact and the movable contact are spaced apart from each to prevent current circulation.

Preferably, the above-described alternative method additionally comprises:
manufacturing a second sub-assembly by:
   coupling together third and fourth casing parts made of an electrically insulating material, wherein the third casing part has a third inclined surface, and the fourth casing part has a fourth inclined surface,
   coupling a second stack of arc-breaking plates to the third casing part and/or to the fourth casing part,
   coupling a second fixed contact to the third upper casing part and/or to the fourth casing part, and
   placing a third magnet on the third inclined surface, and placing a fourth magnet on the fourth inclined surface.

The second sub-assembly is assembled together with the first sub-assembly, and with the top and bottom covers and the movable contact, to configure the switch, such that a major part of the first and second sub-assemblies are enclosed by the top and bottom covers, and the movable contact is electrically in contact with the fixed contact in the On-position, and spaced apart from the fixed contacts in the Off-position.

The magnets are positioned relative to each other in such a way that surfaces of sides of the magnets of the same polarity, form an angle withing the range: more than 0° and less than 110°, and preferably around 100°.

The disclosure offers to the current state of the art a technique to optimize the performance of magnetic blowing in high voltage DC circuit breakers in critical current cases.

The disclosure involves the use of magnets of smaller size/volume achieving considerable savings in raw material consumption, minimizing environmental impact and manufacturing costs for the same effective result, than prior art solutions.

### BRIEF DESCRIPTION OF THE DRAWINGS

To complete the description and in order to provide a better understanding of the disclosure, a set of drawings is provided. These drawings form an integral part of the description and illustrate disclosed embodiments, which should not be interpreted as restricting the scope of protection, but just as examples of how the improvements can be carried out. The drawings comprise the following figures:

FIG. 1.—shows in FIGS. 1A and 1B two representations of magnets arrangement generating a large amount of scattered magnetic flux, according to the prior art.

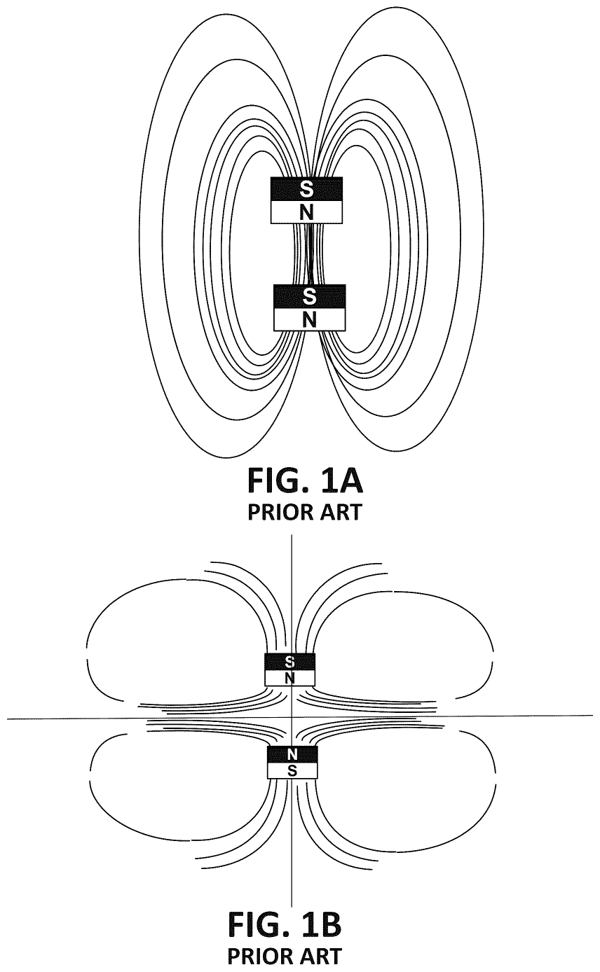

FIG. 2.—shows a representation of magnets arrangement generating a high magnetic flux density region and reduced scattered flux.

FIG. 3.—shows two partial views of a switch, wherein FIG. 3A is a perspective view, and FIG. 3B is an elevational view.

FIG. 4.—shows a perspective and partial view of a switch including arc-breaking plates.

FIG. 5.—shows a perspective and complete view of the switch including the two housing parts in an open position. FIG. 5A shows the switch in an Off position (current circulation impeded), and FIG. 5B shows the switch in an On position (current circulation allowed).

FIG. 6.—shows a perspective cross-sectional view of the switch of the previous figures, with the two housing parts operatively coupled to each other to configure the switch housing or casing. The cross-sectional view of this figure is taken along plane E-E shown in FIG. 7 when the two housing parts are coupled together.

FIG. 7.—shows a top plan view of the switch of the previous figures, with the two housing parts uncoupled.

FIG. 8.—shows two perspective views of an alternative embodiment of the switch, in the On position (FIG. 8A) and with covers, and in the Off position (FIG. 8B).

### DETAILED DESCRIPTION

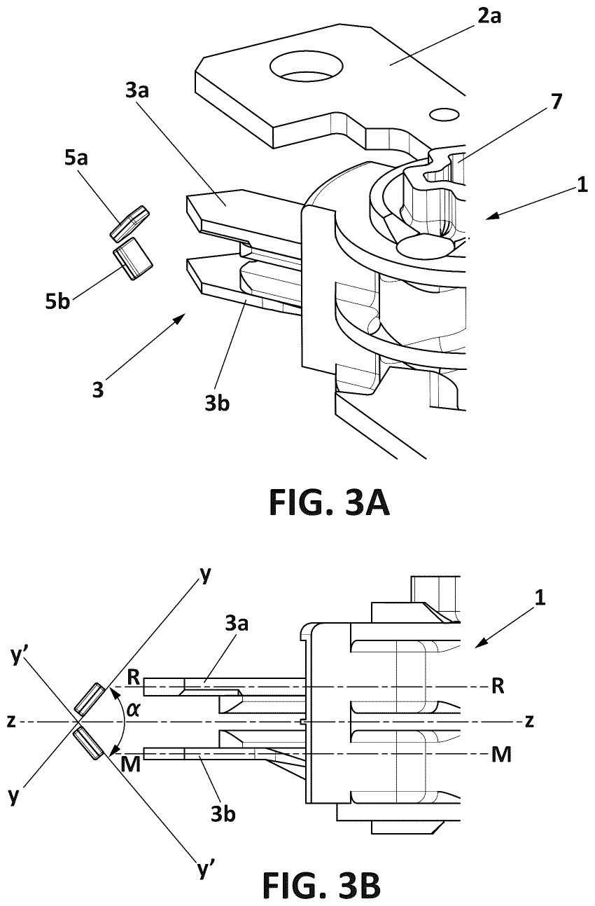

FIGS. 3 to 7 show a preferred embodiment of a switch (1) with magnetic blow-out of electric arc, which comprises a pair of fixed contact (2a, 2b) embodied as metallic plates, and a movable contact (3) which in this embodiment is a rotatable contact rotatable about an axis (X) and placed in between the fixed contacts (2a, 2b).

The movable contact (3) in this embodiment is formed by two contact plates (3a, 3b) parallel to each other and jointly rotatable about the axis (X). The two contact plates (3a, 3b) are attached to a rotor (7).

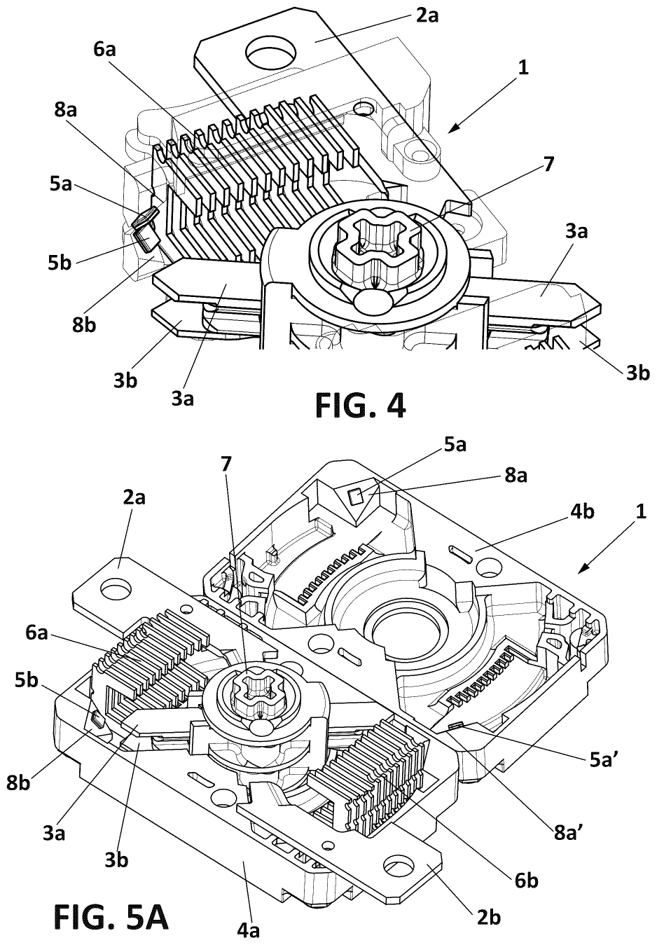

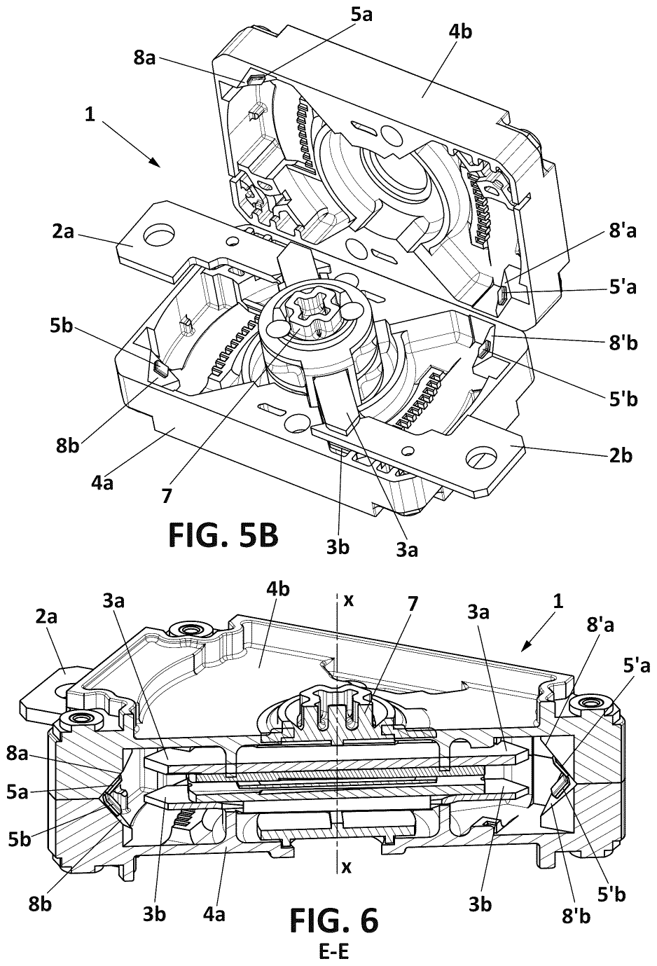

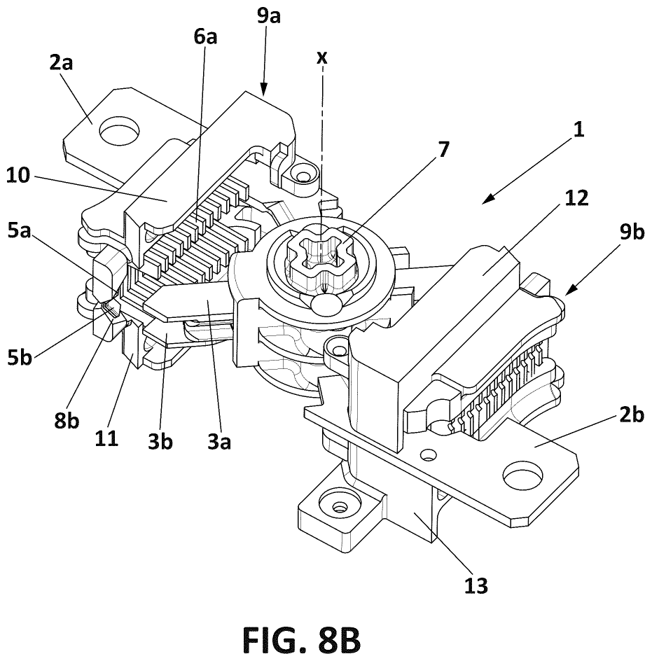

The movable contact (3) is displaceable between an On-position (FIGS. 5B and 8A) in which it is electrically in contact with the fixed contacts (2a, 2b), and an Off-position (FIGS. 4, 5A, 6, 7, and 8B), in which the fixed and the movable contacts are spaced apart from each other to prevent current circulation. In the On-position (FIGS. 5B and 8A), one end of the movable contact (3) is contacting a first fixed contact (2a), and the other end of the movable contact (3) is contacting a second fixed contact (2b).

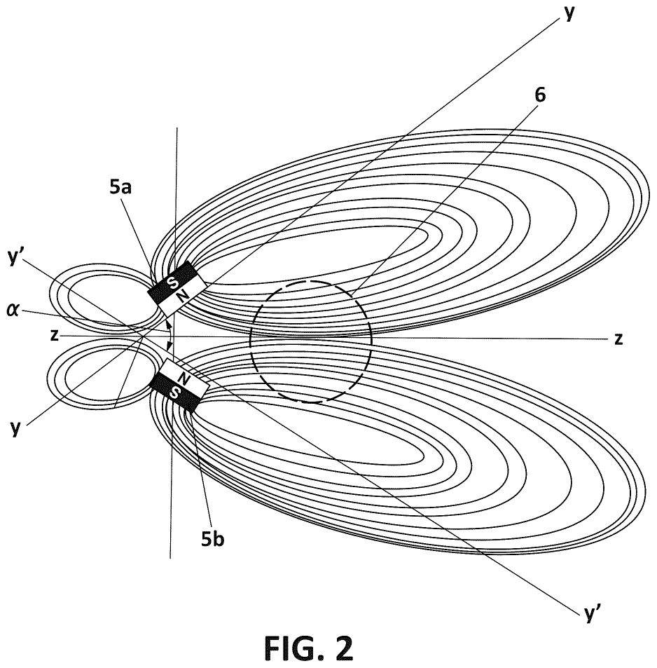

The switch (1) in this embodiment comprises two pairs of magnets (5a, 5b, 5′a, 5′b) placed as shown for example in FIG. 2, that is, in each pair of magnets, the magnets are arranged relative to each other and relative to the fixed and movable contacts (2a, 2b, 3), such that a region (6) of a high-density magnetic flux is generated by the two magnets of each pair, which interferes, at least partially, with an electric arc that may be formed between the fixed and the movable contacts (2a, 2b, 3) when switching from the On-position to the Off-position and vice versa.

In this embodiment, each magnet (5a, 5b, 5′a, 5′b) is a prismatic body having two opposing flat surfaces. However, magnets with other shapes, such as cylindrical, are also encompassed by the disclosure.

As shown in FIG. 2, the magnets (5a, 5b) of the same pair of magnets are placed one above the other and are inclined with respect to each other. Conventionally, each magnet has a positive polarity side and a negative polarity side or North and South sides, and the magnets of the pair of magnets are placed relative to each other, such that sides of the same polarity (either the positive polarity sides or the negative polarity sides) of the two magnets are closer to each other than the sides of the other polarity, or in other words, sides of the same polarity are directly facing each other.

To described more precisely and in view of FIG. 2, a surface of a side of a first magnet (5a) is within a first plane (Y), and a surface of a side of a second magnet (5b) of the same pair of magnets is within a second plane (Y′), and wherein the first and the second planes (Y, Y′) form and angle (α) withing the range: more than 0° and less than 110°. In the example of FIG. 2 the angle (α) is about 70°.

Preferably, the two magnets (5a, 5b) of the same pair of magnets are symmetrically arranged with respect to a plane of symmetry (Z), such that sides of the magnets of the same polarity are closer to the plane of symmetry (Z) than the sides of the other polarity. In the case of FIG. 2, the North sides are closer to each other than the South sides.

As better shown in FIG. 3B, each of the plates (3a, 3b) of the movable contact (3) is movable on a plane (R, M), and the plane of symmetry (Z) is parallel to the planes (R, M). In this way, the region of higher density of magnetic flux, is directed towards a region wherein an electric arc is more likely to appear, thereby, enhancing the blow-out effect.

In an alternative embodiment in which the movable contact (3) is formed by a single plate, this plate would be coplanar with the plane of symmetry (Z).

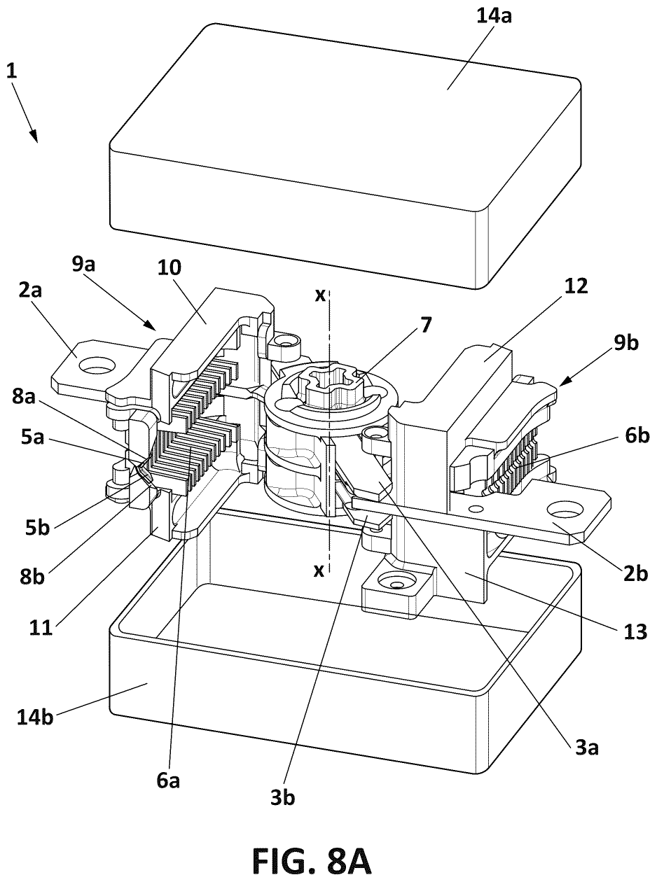

Furthermore, the switch (1) comprises two stacks (6a, 6b) of arc-breaking plates, such that a first stack (6a) of arc-breaking plates is placed nearby a first fixed contact (3a), and a second stack (6b) of arc-breaking plates is placed nearby a second fixed contact (3b). More specifically and as better shown in FIG. 7, each stack (6a, 6b) of arc-breaking plates, is placed downstream the fixed contact to which is closer, with respect to the movement of the movable contact (3) when it moves from the On-position to the Off-position.

Additionally, a first pair of magnets (5a, 5b) is placed downstream the first stack (6a) of arc-breaking plates, and a second pair of magnets (5′a, 5′b) is placed downstream the second stack (6b) of arc-breaking plates, again with respect to the movement of the movable contact (3) when it moves from the On-position to the Off-position.

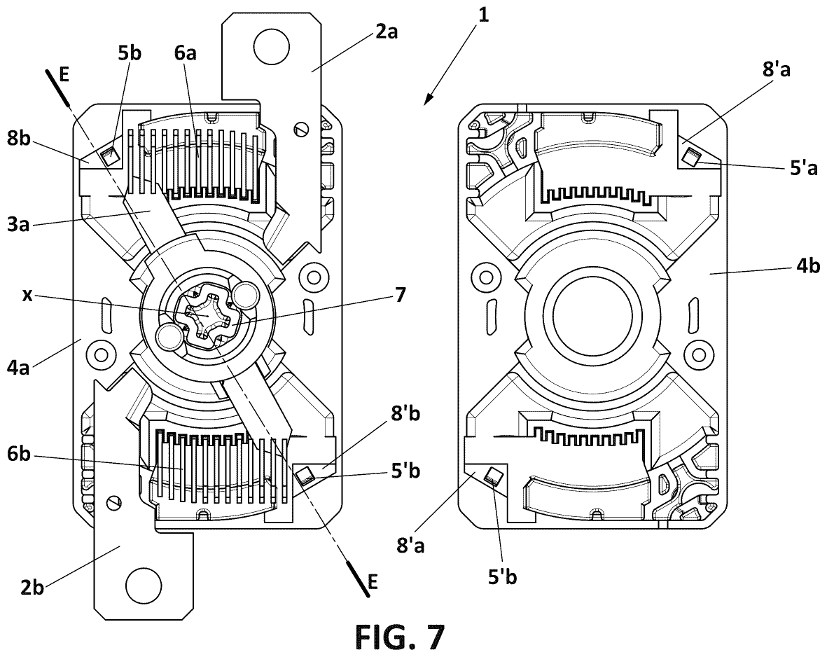

In the preferred embodiments shown in the figures, the switch comprises a housing formed by a first housing part (4a) and a second housing part (4b), both parts made of an electrically insulating material. The two housing parts (4a, 4b) are configured to be placed and coupled one on top of the other, as shown partially in FIG. 6, to configure a switch's housing enclosing: the movable contact (3), part of the fixed contact (2a, 2b), the two stacks (6a, 6b) of arc-breaking plates, and the two pair of magnets (5a, 5b, 5′a, 5′b), all these components arranged as described above.

As shown in FIG. 7, the pair of magnets (5a, 5b, 5′a, 5′b) are diametrically located with respect to the axis (X), or in diametrically arranged corners of the housing part (4a, 4b) which are rectangular in this embodiment.

Each housing part (4a, 4b) is generally a flat body extending on a plane, and wherein inclined surfaces (8a, 8b, 8′a, 8′b) are formed on the inner side or surface of each housing part (4a, 4b), for attaching a magnet of each pair of magnets as shown for example in FIG. 5A, such that one side of each magnet is directly in contact with the respective inclined surface. The magnets may be glued to the respective inclined surface, or attached by any other conventional means.

As better shown in FIG. 6, the magnets (5a, 5b, 5′a, 5′b) are located such that when the first and second housing parts (4a, 4b) are coupled together to configure the switch's housing, the magnets of each pair are placed one above the other and inclined with respect to each other. Moreover, the magnets are separated at the desired distance and relatively close to each other.

In the alternative embodiment of FIGS. 8A, 8B, the switch comprises:
a first sub-assembly (9a) in turn comprising:
   first and second casing parts (10, 11) made of an electrically insulating material, wherein the first casing part (10) has the first inclined surface (8a), and the second casing part (11) has the second inclined surface (8b),
   the first stack (6a) of arc-breaking plates coupled to the first casing part (10) and/or to the second casing part (11),
   the first fixed contact (2a) coupled to the first upper casing part (10) and/or to the second casing part (11), and
   the first pair of magnets (5a, 5b) such that a first magnet (5a) is placed on the first inclined surface (8a), and a second magnet (5b) is placed on the second inclined surface (8b),
a second sub-assembly (9b) in turn comprising:
   third and fourth casing parts (12, 13) made of an electrically insulating material, wherein the third casing part (12) has a third inclined surface (8′a), and the fourth casing part (13) has a fourth inclined surface (8′b),
   the second stack (6b) of arc-breaking plates coupled to the third casing part (12) and/or to the fourth casing part (13),
   the second fixed contact (2b) coupled to the third upper casing part (12) and/or to the fourth casing part (13), and
   a second pair of magnets (5′a, 5′b) such that a third magnet (5′a) is placed on the third inclined surface (8′a), and a fourth magnet (5′b) is placed on the fourth inclined surface (8′b),
a top cover (14a) and a bottom cover (14b), both covers made of an electrically insulating material,
the movable contact (3) displaceable between an On-position in which it is electrically in contact with the first and second fixed contacts (2a, 2b), and an Off-position in which the fixed contacts (2a, 2b) and the movable contact (3) are spaced apart from each to prevent current circulation, and
wherein the first sub-assembly (9a), the second sub-assembly (9b) and the top and bottom covers (14a, 14b) are assembled together to configure the switch (1), such that a major part of the first and second sub-assemblies are enclosed by the top and bottom covers (14a, 14b), and wherein
the movable contact (3) is displaceable between an On-position in which it is electrically in contact with the first and second fixed contacts (2a, 2b), and an Off-position in which the fixed contacts (2a, 2b) and the movable contact (3) are spaced apart from each to prevent current circulation.

A method of manufacturing a switch as the one shown in the figures comprises the steps of: providing a first housing part (4a) and a second housing part (5b), both parts made of an electrically insulating material,
wherein each housing part (4a, 4b) is formed as a generally flat body extending respectively on a first and second plane, and wherein each housing part (5a, 5b) is formed to have at an internal side thereof, inclined surfaces (8a, 8b, 8′a, 8′b) with respect respectively to the first or the second plane,
providing at least two pair of magnets (5a, 5b, 5′a, 5′b),
attaching the first and second magnets respectively on the inclined surfaces (8a, 8b, 8′a, 8′b) of the first and the second housing parts (5a, 5b), such that sides of the first and second magnets of the same polarity are placed directly in contact with the respective inclined surface (8a, 8b, 8′a, 8′b),
providing a movable contact (3) and two fixed contacts (2a, 2b),
bringing the first and the second housing parts (4a, 4b) together to configure a switch housing, and in a way that the movable contact (3) and at least part of the fixed contacts (2a, 2b), are enclosed within the first and second housing parts (4a, 4b), such that the movable contact (3) is displaceable between an On-position in which it is electrically in contact with the fixed contact, and an Off-position in which the fixed and the movable contacts are spaced apart from each to prevent current circulation, and
wherein the inclined surfaces (8a, 8b, 8′a, 8′b) and the magnets (5a, 5b, 5′a, 5′b) are located respectively in first and the second housing parts, such that when the housing parts are placed one on top of the other and coupled, the magnets are arranged to generate a magnetic flux which interfere, at least partially, with an electric arc that may be formed between the fixed and the movable contacts when switching from the On-position to the Off-position and vice versa,
and wherein by bringing the first and the second housing parts (4a, 4b) together to configure a switch housing, the magnets (5a, 5b, 5′a, 5′b) in each pair of magnets, are positioned inclined with respect to each other, for example as shown in FIG. 6.

1. A switch with magnetic blow-out of electric arc, comprising:
a fixed contact and a movable contact, wherein the movable contact is displaceable between an On-position in which it is electrically in contact with the fixed contact, and an Off-position in which the fixed and the movable contacts are spaced apart from each to prevent current circulation,
wherein the switch further comprises at least a pair of magnets placed one above the other, and arranged such that a generated magnetic flux would interfere, at least partially, with an electric arc that may be formed between the fixed and the movable contacts when switching from the On-position to the Off-position and vice versa,
wherein each magnet includes a positive polarity side and a negative polarity side, and wherein the magnets of the pair of magnets are placed relative to each other, such that sides of the same polarity of the two magnets are closer to each other than the sides of the other polarity, and
wherein the magnets of the pair of magnets are inclined with respect to each other.

2. The switch according to claim 1, wherein the magnets of the pair of magnets are arranged relative to each other, such that a surface of a side of one magnet is within a first plane, and a surface of a side of the other magnet is within a second plane, and wherein the first and the second planes form and angle withing the range more than 0° and less than 110°.

3. The switch according to claim 1, wherein the two magnets of the pair of magnets are symmetrically arranged with respect to a plane of symmetry (Z), and wherein sides of the magnets of the same polarity are closer to the plane of symmetry than the sides of the other polarity.

4. The switch according to claim 3, wherein the movable contact is movable on a third plane, and wherein the plane of symmetry (Z) is coplanar with the third plane, or wherein the plane of symmetry is parallel to the third plane.

5. The switch according to claim 1, further comprising at least one stack of arc-breaking plates placed nearby the fixed contact and the movable contact, and downstream the movable contact when the movable contact is in the On-position, and wherein the pair of magnets are placed downstream the stack of arc-breaking plates with respect to the movement of the movable contact from the On-position towards the Off-position.

6. The switch according to claim 1, wherein the movable contact is a rotatable contact rotatable about an axis, and wherein the switch includes two pairs of magnets which are diametrically arranged with respect to the axis.

7. The switch according to claim 5, further comprising two fixed contacts and two stacks of arc-breaking plates, and wherein the movable contact includes two contact plates parallel to each other and projecting from the axis (X) and configured for contacting with the two fixed contacts in the On-position of the switch.

8. The switch according to claim 1, comprising a housing made of an electrically insulating material enclosing: the movable contact, part of the fixed contact, and the magnets, wherein the housing is formed by a first housing part and a second housing part, wherein one magnet is attached to an internal surface of the first housing part and the other magnet is attached to an internal surface of the second housing part, and wherein the magnets are located such that when the first and second housing parts are coupled together to configure the housing, the magnets are placed one above the other.

9. The switch according to claim 8, wherein each housing part is generally a flat body extending on a plane, and wherein each housing part includes in its inner side, a surface inclined with respect to said plane, and wherein a magnet of the pair of magnets is placed on said inclined surface such that one side of the magnet is directly in contact with that inclined surface.

10. The switch according to claim 1, comprising:
at least a first sub-assembly comprising:
first and second casing parts made of an electrically insulating material, wherein the first casing part includes a first inclined surface, and the second casing part includes a second inclined surface,
a first stack of arc-breaking plates coupled to the first casing part and/or to the second casing part,
a first fixed contact coupled to the first casing part and/or to the second casing part, and
a first pair of magnets such that a first magnet is placed on the first inclined surface, and a second magnet is placed on the second inclined surface,
a top cover and a bottom cover, both covers made of an electrically insulating material, and
the movable contact,
wherein the first sub-assembly and the top and bottom covers are assembled together to configure the switch, such that a major part of the first sub-assembly is enclosed by the top and bottom covers, and wherein the movable contact is displaceable between an On-position in which it is electrically in contact with the first fixed contact, and an Off-position in which the fixed contact and the movable contact are spaced apart from each to prevent current circulation.

11. The switch according to claim 2, wherein each magnet is a prismatic or a cylindrical body having two opposing flat surfaces, the flat surfaces being respectively within the first and second plane.

12. The switch according to claim 1, adapted to feature a working voltage within the range 1500-2000 VDC.

13. A method for manufacturing a switch with magnetic blow-out of electric arc, the method comprising:
providing a first housing part and a second housing part, both parts made of an electrically insulating material,
wherein each housing part has been formed as a generally flat body extending respectively on a first and second plane, and wherein each housing part is formed to have at an internal side thereof, an inclined surface with respect respectively to the first or second plane,
providing at least a pair of magnets, such that each magnet includes a positive polarity side and a negative polarity side,
attaching the first and second magnets respectively on the inclined surfaces of the first and the second housing parts, such that sides of the first and second magnets of the same polarity are placed directly in contact with the respective inclined surface,
providing a movable contact and at least a fixed contact, and
bringing the first and the second housing parts together to configure a switch housing, and in a way that the movable contact and at least part of the fixed contact, are enclosed between the first and second housing parts, such that the movable contact is displaceable between an On-position in which it is electrically in contact with the fixed contact, and an Off-position in which the fixed and the movable contacts are spaced apart from each to prevent current circulation,
wherein the inclined surfaces and the magnets are located respectively in first and the second housing parts, such that when the housing parts are placed one on top of the other and coupled, the magnets are arranged to generate a magnetic flux which interfere, at least partially, with an electric arc that may be formed between the fixed and the movable contact when switching from the On-position to the Off-position and vice versa,
and wherein by bringing the first and the second housing parts together to configure a switch housing, the magnets are positioned inclined with respect to each other.

14. The method according to claim 13 wherein the magnets are positioned relative to each other in such a way that surfaces of sides of the magnets of the same polarity form an angle withing the range more than 0° and less than 110°.

15. The method according to claim 13, comprising:
manufacturing at least a first sub-assembly by:
coupling together first and second casing parts made of an electrically insulating material, such that the first casing part includes a first inclined surface, and the second casing part includes a second inclined surface, coupling a first stack of arc-breaking plates to the first casing part and/or to the second casing part,
coupling a first fixed contact to the first casing part and/or to the second casing part, and
placing a first magnet on the first inclined surface, and placing a second magnet on the second inclined surface,
providing a top cover and a bottom cover, both covers made of an electrically insulating material,
proving a movable contact, and
assembling together the first sub-assembly, the top and bottom covers and the movable contact, to configure the switch, such that a major part of the first sub-assembly is enclosed by the top and bottom covers,
wherein the movable contact is displaceable between an On-position in which it is electrically in contact with the first fixed contact, and an Off-position in which the fixed contact and the movable contact are spaced apart from each to prevent current circulation.
